(19) United States
(12) Patent Application Publication
(10) Pub. No.: US 2007/0084471 A1
(43) Pub. Date: Apr. 19, 2007

(54) Shock absorbing dental device

(76) Inventors: Salvatore Napoli, Florham Park, NJ (US); Laura Bardach, Boonton, NJ (US); James Geduldig, Boonton, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/250,210

(22) Filed: Oct. 14, 2005

(51) Int. Cl. A61C 5/14

(52) U.S. Cl. 128/859

(57) ABSTRACT

An intraoral dental device includes an insert for protecting the teeth, dental arches, mandible, maxilla, temporal mangila joint and lips of the wearer from impact that may arise in athletic activities. The insert is an open cell structure which may optionally contain a fluid material, such as hydrogels, amorphous solids, semisolids, liquids and/or gases. The insert may be permanently or resiliently deformable whereby a portion of the fluid material, if present, is expelled from the insert's cells. The inserts are replaceable after they are rendered ineffective from the sustained impact.

### BACKGROUND OF THE INVENTION

The present invention relates to a method and dental device for protecting the teeth, dental arches, mandible, maxilla, temporomandibular joint and lips, while optionally providing a beneficial agent to the teeth, and more particularly, to an intra-oral dental device that is worn on an arch of teeth.

Injury to the teeth and associated structures is a serious risk in many sports and athletic activities. Associated structures include the dental arches, upper and lower jaws (maxilla and mandible), temporomandibular joints, lips and tongue. A significant percentage of these injuries may be prevented or attenuated by the use of a mouthguard.

The primary function of a mouthguard is to redistribute the force of a potentially damaging blow to the teeth and associated structures over an extended period of time and a larger surface area. In this way, the peak force necessary to break and/or damage the teeth and associated structures may not be reached. However, although the peak force necessary to cause injury may be attenuated, the total force applied remains the same. The reason for this is that known mouthguards are fully resilient and only deform temporarily.

In a collision, the impact will force the mouthguard material against the teeth. Although conventional nondeformable mouthguard materials will momentarily deform and thereby diminish the peak impulse of force by diffusing the force over time, the total force that is ultimately transmitted to the teeth and associated structures is the same, as the mouthguard material rebounds from its deformation. The force that causes deformation of the material is stored and released when the material returns to its original shape. This places a limit on the protectiveness of conventional mouthguards in that the total force is still imparted to the teeth and associated structures.

Athletes in many sports wear mouthguards for prolonged periods in an effort to prevent those injuries. This results in other concerns that have not been addressed by known mouthguards. It is common knowledge that when these athletes engage in strenuous physical activity, they lose and must replace significant amounts of fluids, nutrients and calories. In order to hydrate themselves, and replenish their energy, athletes must drink large quantities of fluids and eat foods that are very often cariogenic. These cariogenic fluids and materials cover the teeth, and when a mouthguard is inserted afterwards, the teeth are acted upon by cariogenic bacteria in an ideal environment, shielded from the buffering ability of saliva.

In athletes, another factor that serves to diminish salivary flow around the teeth includes the general increase in autonomic sympathetic tone of the nervous system. Whatever the cause, reduced salivary flow greatly increases the incidence of dental caries and periodontal disease.

Mouthguards are typically made from plastic materials such as an ethylene vinyl acetate copolymer (EVA). There are several categories of known mouthguards: mouthguards that are stock premolded products and made in a variety of sizes; home or self-moldable to suit the physical characteristics of the user; and custom molded by a dentist or other professional to suit the characteristics of the user. Regarding physical protection, stock mouthguards are typically the cheapest and least effective in use while the custom molded and shaped mouthguards are the most expensive and effective in their impact absorbent properties.

Accordingly, there is an unsolved need for an intra-oral dental device in the nature of a mouthguard that overcomes these deficiencies and provides effective shock absorbing properties so as to protect the teeth, dental arches, mandible, maxilla, temporomandibular joint, and lips of the wearer.

### SUMMARY OF THE INVENTION

In accordance with one aspect of the present invention, the dental device constructed in the nature of a mouthguard diminishes the total force imparted to the teeth and associated structures by a potentially damaging blow, in addition to distributing the force over a greater time and a larger surface area. The attenuation of the total force is effected by the application, in one or more of several embodiments, of an open cell structure containing a fluid material. The open cell structure is designed as a shock absorbing functional unit hereinafter called an Impact Attenuation Component or IAC that may be an integral nondetachable part of the mouthguard or a separate detachable and replaceable unit that is affixed into the mouthguard.

The IAC of the mouthguard provides mechanical protection properties and optionally controls secondary damage to teeth engendered by the use of mouthguards. The principles employed by the IAC as to mechanical protection provides the mouthguard with a crumple zone wherein a specific region or regions of the IAC are deformed or permanently crumpled in order to absorb as much of the potentially damaging impact of a collision as possible. In this way, less of the total kinetic energy of the collision impact is transferred to the teeth or other associated structures.

The energy that is absorbed in the deformation or crumpling of the IAC is not stored as elastic energy, but is dissipated as kinetic energy in the movement of the fluid material, heat, sound and other entropy increasing mechanisms with the deformation or crumpling of the crumple zone of the IAC. The main function of the dental device is to limit the damage to and within the IAC of the mouthguard to the greatest degree possible, and thereby reduce injury to teeth and associated structures and brain.

In accordance with one embodiment, the Impact Attenuation Component or IAC may be an integrated component of the dental device or mouthguard. In this embodiment, if a potentially damaging blow to the teeth and associated structures causes the deformation or crumpling of the IAC, the protective properties of the IAC is exhausted and the mouthguard must be replaced.

In accordance with another embodiment, the Impact Attenuation Component or IAC may be a separate component in the form of a cartridge or an insert that is inserted into a receptacle or inset in a wall of the dental device or mouthguard. In this embodiment, if a potentially damaging blow to the teeth and associated structures causes the deformation or crumpling of the IAC, the protective properties of the IAC is exhausted and the cartridge or insert must be removed and replaced into the reusable dental device or mouthguard.

The IAC, by way of one example, is composed of a semi-rigid skeletal framework or superstructure that serves to provide sufficient rigidity to the contained fluid material, for the purpose of handling and insertion into the mouthguard, as well as having 3-dimensional characteristics intended to contribute to the protective nature of the insert as well as adequately retaining the fluid material until the occurrence of an energy/momentum-imparting event of the type that mouthguards are intended to protect against. As hereinafter described, the fluid material may be any amorphous solid or semi-solid, gel, liquid or gas, including air, that will change its shape under an applied force. In the case of a gas, the density of the gas may also change under an applied force.

When a potentially damaging blow is imparted to the teeth and associated structures, the IAC deforms or crumples. The skeletal framework collapses in a controlled manner forcing out the contained fluid material in controlled multiple directions. This fluid material carries away kinetic energy that would otherwise be directed at and cause damage to the vital structures. The energy that is absorbed in the deformation or crumpling of the IAC is not stored as elastic energy but is dissipated as kinetic energy in the permanent movement of the fluid material, heat, sound and other entropy increasing mechanisms within the crumple zone of the IAC.

The skeletal framework of the IAC may be formed from resilient polymer materials, which allow the framework to deform during impact, but returning to its original or near original state after the impact.

The deformation causes the contained fluid material within the open cell structure of the framework to be discharged thereby dissipating the kinetic energy from the applied force. In another embodiment, the skeletal framework may be constructed of rigid polymer material which permanently crumples upon application of sufficient force. In this event, the fluid material will also be discharged from the open cell structure of the framework, which framework has been permanently crumpled. It is also contemplated that the skeletal framework can be formed from other materials, such as fibrous and cellulosic materials. In any case, the IAC is no longer suitable for use.

In accordance with another embodiment of the dental device, proactively protective elements are incorporated in the design of the IAC. Although protection of the oral soft tissues and dentoalveolar structures is the primary purpose of this dental device, consideration is also given to the secondary damage caused or facilitated by mouthguards. In one embodiment of the design of the IAC, the skeletal superstructure has an open-cell design. The semi-solid or gel-like contents of the cells or compartments may contain chemical agents held in suspension or solution. These agents may be active or inactive substances. During the time that the protective mouthguard is employed, these agents elute into the saliva and fluids coating the teeth and associated structures. The incorporation of hydrophilic materials into the fluid materials used in the mouthguard that are neutral or beneficial to the denition, e.g., agents such as xylitol, is a significant advantage in protecting the teeth from the increased cariogenic environment found when mouthguards are use in athletic activities.

In accordance with one embodiment of the present invention, there is described a dental device comprising a carrier adapted for receiving an arch of teeth, the carrier including an outer wall having at least one insert therein, the insert comprising a shock absorbing body adapted to be rendered inoperable upon application of a sufficient force thereto.

In accordance with one embodiment of the present invention, there is described a dental device comprising a carrier having an outside wall, an inside wall, and an occlusal wall connecting the outside wall to the inside wall, the outside wall having at least one inset, at least one shock absorbing insert adapted to be removably received within the inset, the insert comprising an open cell body of deformable material having a plurality of voids, and a fluid material within said plurality of voids, whereby deformation of the body at least partially expels said fluid material from the voids.

In accordance with one embodiment of the present invention, there is described a dental device comprising a carrier adapted for receiving an arch of teeth, the carrier including an outside wall, and a shock absorbing body within a portion of the outside wall, said body -having an operative shock absorbing condition and an inoperative condition, the body irreversibly changing from the operative shock absorbing condition to the inoperative condition upon application of a sufficient force thereto.

In accordance with one embodiment of the present invention, there is described an insert adapted for use in a shock absorbing dental device, the insert comprising a body having an operative shock absorbing condition and an inoperative condition, the body irreversibly changing from the operative shock absorbing condition to the inoperative condition upon application of a sufficient force thereto.

In accordance with one embodiment of the present invention, there is described an insert adapted for use in a shock absorbing dental device, the insert comprising a first backing layer, a body supported on the backing layer, the body comprising an open cell structure including a plurality of voids having opposing first and second open ends, and a fluid material within the plurality of voids, the first backing layer closing the first ends of the voids.

In accordance with one embodiment of the present invention, there is described a method for protecting the teeth of a user from an impact, the method comprising positioning an arch of teeth within a channel formed in a carrier, the carrier including an outer wall having at least one insert therein, the insert comprising a shock absorbing body adapted to be rendered impermeable upon application of a sufficient force thereto, and replacing the insert with another one of the inserts when the insert is rendered inoperable upon application of a sufficient force thereto.

### BRIEF DESCRIPTION OF THE DRAWINGS

The above description, as well as further objects, features and advantages of the present invention will be more fully understood with reference to the following detailed description of a shock absorbing dental device, when taken in conjunction with the accompanying drawings, wherein:

FIG. 1 is a perspective unassembled view of a dental device in the nature of a mouthguard including a replaceable Impact Attenuation Component in accordance with one embodiment of the present invention;

FIG. 2 is cross-sectional view taken along Lines 2-2 in FIG. 1; and

FIG. 3 is a perspective view of the Impact Attenuation Component in accordance with one embodiment of the present invention;

FIG. 4 is a cross-sectional view of a dental device constructed in accordance with still another embodiment of the present invention; and

FIG. 5 is a is a cross-sectional view of a dental device constructed in accordance with still another embodiment of the present invention.

### DETAILED DESCRIPTION

In describing the preferred embodiments of the subject matter illustrated and to be described with respect to the drawings, specific terminology will be resorted to for the sake of clarity. However, the invention is not intended to be limited to the specific terms so selected, and is to be understood that each specific term includes all technical equivalence which operate in a similar manner to accomplish a similar purpose.

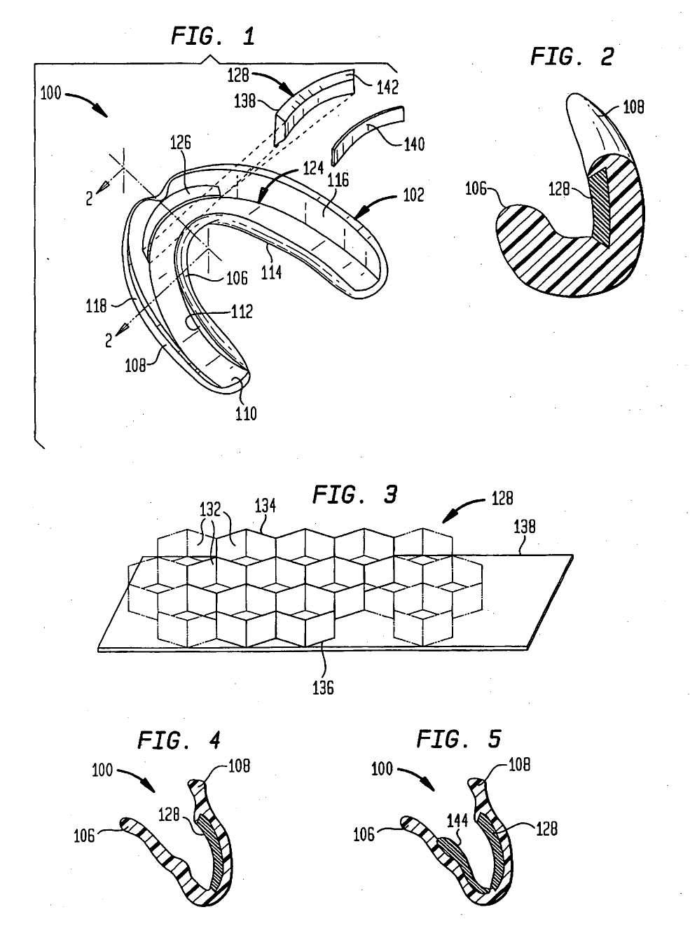

Referring to the drawings, and specifically FIGS. 1 and 2, there is illustrated a dental device having shock absorbing properties for protecting the wearer's teeth, dental arches, mandible, maxilla, temporomandibular, and lips. In addition, as to be described hereinafter, the dental device is adapted for optionally providing a beneficial agent intra-orally to the teeth in a proactive manner, for example, such as protecting the teeth from the increased cariogenic environment found when mouthguards are used, particularly during athletic activities.

As shown in the drawings, the intra-oral dental device as to be described is in the nature of a mouthguard, generally designated by reference number 100. The mouthguard 100 includes a U-shaped carrier 102 formed by an inside wall 106, an outside wall 108, and an occlusal wall 110. The outside wall 108 is commonly referred to as the buccal/labial wall. The inside wall 106 may also be referred to as the lingual/palatal wall. The inside wall 106 has an inner surface 112 and an outer surface 114. Similarly, the outside wall 108 includes an inner surface 116 and an outer surface 118. Likewise, the occlusal wall 110 has an inner surface 120 and an outer surface 122.

The inside wall 106, outside wall 108, and occlusal wall 110 provide the carrier 102 with a channel 124 extending therebetween so as to serve as a recess for receiving an arch of teeth. It is generally expected that the mouthguard 100 will be positioned over the user's upper teeth, whereupon the mouthguard may be referred to as a maxillary device. However, it is also contemplated that the mouthguard 100, if so desired, can be worn on the lower teeth, whereupon it may be referred to as a mandibular device. Generally, it is not required that the lower teeth be shielded from impact during athletic activities. In this regard, it is common for humans to have an overbite whereby the upper teeth protrude over the lower teeth, thereby shielding the lower teeth from injury. When the mouthguard 100 is worn as a maxillary device, the inner surface 112 of the inside wall 106 touches the user's teeth, gingival and pallet, and the outside surface 114 of the inside wall may touch the upper (dorsal) surface of the user's tongue.

To the extent that the mouthguard 100 is worn as a mandibular device, the inner surface 112 of the inside wall 106 touches the teeth, gingival and lingual surface of the dentolavoliar, and the outer surface 114 of the inside wall will touch the under surface (ventral) of the tongue. In a maxillary and mandibular device, the inner surface 116 of the outside wall 108 touches the user's gingival and teeth and the outer surface 118 of the outside wall touches the user's cheeks and lips.

A mouthguard as thus far described is disclosed in applicant's co-pending Application Publication No. 20030205234 entitled Therapeutic and Protective Dental Device Useful as an Intra-Oral Delivery System; and co-pending Application Ser. No. 11/212,220, entitled Intra-Oral Device for Treating Obesity, filed on Aug. 26, 2005, the disclosures of which are incorporated herein by reference.

In the preferred embodiment, the mouthguard 100 when worn as a maxillary device has only a single channel 124 for receiving the arch of teeth. Other embodiments may have two channels for receiving an arch of teeth from the upper jaw and an arch of teeth from the lower jaw. In the embodiment with two channels, the mouthguard 100 has a clam-shape, with the occlusal surfaces of each channel facing each other. In use, one channel will face the user's nose for receiving the teeth from the upper jaw, and the other channel will face the user's chin for receiving the teeth from the lower jaw.

Suitable material for carrier 102 may, for various embodiments, be any such material as is currently used in therapeutic intra-oral devices or sports mouthguards. Mouthguards are typically made from polymer materials such as an ethylene vinyl acetate copolymer (EVA). Additives may be added to the EVA itself to provide special chemical or physical properties for different application. In some embodiments of the mouthguard 100, flavoring and aromatic agents may be added to the polymer. Colorants, perfumes and softening agents may be added as well. For example, German patent 4011204 discloses a mouthguard material consisting of an EVA copolymer material, polycaprolactone, colorants, perfumes and polyvinyl acetate (PVA). The softening point of the resultant mouthguard is reduced for ease of manipulation and shaping.

The carrier 102 is provided with one or more insets 126 for receiving one or more IACs. In the preferred embodiment of a maxillary carrier 102, at least one inset 126 is formed within the inner surface 116 of the outside wall 108 in the nature of a recess. As such, the thickness of the outside wall 108 overlying the inset 126 is thinner than the remaining portion of the outside wall. In the preferred embodiment, the bottom edge of the inset 126 will be positioned below the location of the incisal edges of the teeth, and extends to a length so as to cover an area from the right canine to the left canine, e.g., about 35 mils. It is contemplated that the height of the insert 128 may be about 10-15 mils and a thickness of about 1-5 mils.

The inset 126 is adapted to receive at least one insert 128 in the nature of an IAC. The surrounding side walls 130 of the inset 126 are undercut to provide for a mechanical “snap-in” of the insert 128. As viewed in a plane perpendicular to the surfaces of the inside and outside walls 106, 108 (see FIG. 2), the surrounding sidewalls 130 of the inset converge in a direction towards each other in order to accomplish this snap-in, or locking, feature. The sidewalls of the inset 126 and insert 128 may join at a bevel, rounded edge, obtuse, right or acute angle, or any other configuration that achieves the snap-in feature. Any other arrangement may be used for releasably securing an insert. 128 within the inset 126, e.g., two sided tape, adhesives, and the like.

As thus far described, the inset 126 is formed within the inner surface 116 of the outside wall 108 so as to receive an insert 128. It is to be understood that multiple insets 126 may be provided to receive a plurality of inserts 128 if so desired. Although the inset 126/insert 128 has been illustrated as being rectangular in shape, it is to be understood that other shapes such as oval, square, round triangular and the like can be incorporated. Furthermore, although in the preferred embodiment the inset 126 is formed within the inside surface 116 of the outer wall 108, it is also contemplated that the inset could be formed within the outer surface 118 of the outer wall 108 if so desired.

Referring to FIG. 3, the insert 128 is constructed from a frame like or Open cell structure. One example of a suitable open cell structure is a honeycomb structure or grid-like matrix of open cells 132. The cells 132 are interconnected so as to form a planar layer having an open first end 134 and an opposing open second end 136. The insert 128 may be formed as a flat planar member as shown in FIG. 3 or as a arcuate shaped planar member as shown in FIG. 1. In the case of the insert 128 being originally formed as a flat planar member, it is contemplated that the insert will be flexible to enable flexing or bending of the insert into an arcuate shape such as shown in FIG. 1 so as to be received within the inset 126.

In one embodiment, the insert 128 will further include a backing layer 138 generally of polymer material. The backing layer will result in the insert 128 having a closed end so as to support fluid material within the cavities provided by the cells. The backing layer 138 may be formed from the same or different material from that of the cells 132. It is contemplated that the backing layer 138 will be formed from material which is impervious to the fluid material to be stored within the cells 132. For example, the backing layer 138 can be formed from polymer materials such as ethylene vinyl acetate copolymer (EVA). Likewise, the cells 132 can be formed from EVA material, being integrally molded with the backing layer 138, or separately formed and subsequently attached to one another. Furthermore, the cells 132 can be formed to have one end, e.g., end 136, already closed as a blind end and/or formed with a blockage, whereupon the backing layer 138 might not be required. It is also contemplated that the cells 132 can be formed of non polymer materials such as cellulosic materials, various fiber composites and the like. It is to be understood that the insert 126 can be constructed from any materials suited for retaining the fluid material within the cells 132 while providing the requisite deformation or crushing properties as to be described hereinafter.

As previously described, the cells 132 of the insert 128 may contain a fluid material to facilitate absorption of the force created by a blow to the mouthguard 100. The fluid material, by way of example, includes any amorphous solids, hydrogels, semi-solids, gels, clay like material such as putty, liquids such as water or gases such as nitrogen and air. Examples of, suitable fluid materials include gases: such as air, nitrogen, carbon dioxide; liquids: such as distilled water, saline or water containing biologically compatible electrolytes, biocompatible oils such as mineral oil or vegetable oil; semisolids/highly viscous liquids: such as biodegradable hydrogels, insert biocompatible hydrogels, silicone hydrogels, natural or synthetic gums, latex, gelatin, startch, oectin, silicone-based polymers, biocompatible organoclays; and other fluids with thixotropic additives.

Depending upon the nature of the fluid material, it may be desireable to provide a confinement layer 140 so as to close the opened end 134 of the cells 132 within the insert 128. The confinement layer 140 can be adhered to the upper edges of the cells 132 using any known technique, for example, thermal bonding, adhesives and the like. The confinement layer 140 may be formed from materials which are permeable or semi-impermeable to the contained fluid material. For example, the confinement layer 140 may be formed from impermeable materials, but designed to rupture upon application of a sufficient force to the mouthguard 100 for release of the fluid material to provide the shock absorbing properties. In another embodiment, the confinement layer 140 may be semi-permeable, allowing the fluid material to be discharged through pores or openings within the confinement layer upon application of a sufficient force to the insert 128. As such, the shock absorbing properties of the insert 128 are rendered by virtue of the discharge of the fluid material from within the cells 132, which may optionally include permanent crushing or deformation of the cell structure of the insert. In the case of gases, it is generally desireable that the confinement layer 140 be impermeable to the gas. As such, the shock absorbing properties are obtained by the cell structure of the insert 128 permanently deforming or crushing during impact so as to absorb the applied forces to the mouthguard 100. It is further contemplated that a protective peelable layer (not shown) may be adhered to the confinement layer 140 or directly to the open end 134 of the cells 132 if desired. The peelable layer may be removed before or after inserting the insert 128 into the inset 126 of the mouthguard 100 but before the insert-mouthguard assembly is inserted into the mouth.

Although the mouthguard 100 has been described as including an insert 128 containing a fluid material, it is to be understood that the insert may be provided without the fluid material, while still possessing shock absorbing properties. In this regard, the cell like structure of the insert 128 will be designed to be permanently crushable or deformable upon impact to the insert from a blow to the mouthguard 100. This deformation, crushing or crumpling of the insert 128 will absorb the applied force to prevent injury to the protected area.

In use, one or more inserts 128 are removably inserted into within the inset 126 within the mouthguard 100. The open end 134 or side bearing the confinement layer 140 faces the wearers teeth. The insert 128 is retained within the inset 126 in the manner as previously described, such as by means of the converging edges 130 of the inset. In this regard, the insert 128 will be provided with lateral edges 142 of corresponding shapes so as to mate with the edges 130 of the inset 126. This results in the insert 128 having a snapped in feature to allow the insert to be removably locked within the inset 126.

Upon application of a force to the mouthguard 100, the force is absorbed by the insert 128 to prevent injury to the teeth, dental arches, mandible, maxilla, thermal mandible joint and lips. By way of one example, the insert 128 may be deformed while expelling a portion of the contained fluid material from the cells 132. This can easily be visually detected by adding a coloring agent to the fluid material. This deformation and expelling of the fluid material will absorb the applied force. As a result of the loss of fluid material, the insert 128 will not be suitable for continued use as a shock absorbing element. In this regard, the now spent insert 128 can be replaced with a new insert before continued use of the mouthguard 100. In addition to the loss of the fluid material within the cells 132, the cell like structure of the insert 128 may be permanently deformed, crushed or crumpled. This permanent deformation, crushing or crumpling of the insert 128 will absorb the applied force, irrespective of whether fluid material is present within the cells 132. As a result, the insert 128 has been permanently deformed, thereby rendering it unusable for future protection against applied force to the mouthguard 100. Here again, the insert 128 may be replaced with a new insert to provide the shock absorbing properties for the mouthguard 100.

Generally, by way of example only, when no fluid material is provided within the cells 132, the cell like structure of the inserts 128 will be formed from permanently deformable or crushable material. In the case where fluid material is to be discharged from the cells 132, the cell like structure of the insert will be designed to be deformable so as to expel at least a portion of the fluid material. However, the cell like structured is not required to be permanently crushable or deformable, but may return to its original shape. In either event, the loss of the fluid material or permanent deformation of the cell like structure will render the insert 128 unsuitable for future use as a shock absorbing protective device. In the case of gases, it is contemplated that the cell like structure of the insert 128 will be of a permanently crushable or deformable nature. As such, it is generally not contemplated that gases will be expelled from the cells 132, but may so if desired through a semi-permeable confinement layer 140. It should therefore be appreciated that the shock absorbing properties of the insert 128 are attained by the deformation of the insert, either resiliently or permanently, as well as the expelling of the fluid material if present within the cells 132. Accordingly, the inserts 128 may be designed to accommodate various levels of force being applied, defending upon the anticipated activities of the wearer.

The insert 128, as thus far described, is removably insertable within an inset 126 within the mouthguard 100. This allows for reuse of the mouthguard 100 after an impact upon replacing the insert 128 with another insert. It is also contemplated that the insert 128 may be integrally formed with the mouthguard 100 as one piece, thereby being non-replaceable. As shown in FIG. 4, the insert 128 is integrally formed within the mouthguard 100. As a result, the mouthguard 100 is generally rendered non functional for absorbing shock once the insert 128 has been rendered ineffective after application of an impact force thereto. This necessitates that the mouthguard 100 as a whole be replaced, i.e., a throw away design.

A secondary feature of the mouthguard 100 is for protecting the teeth from the increased cariogenic environment found when mouthguards are used in athletic activities. To this end, known beneficial agents for this purpose, e.g., prevent and/or reverse the decalcification of teeth, are zylitol, remineralizing agents and acid-neutralizing agents which can be added to the fluid material within the cells 102.

Any number of beneficial agents, including active and inactive agents, can be incorporated into the fluid material of the present invention. Numerous agents suitable for this purpose are disclosed in applicant's aforementioned co-pending application Ser. No. 11/212.220, the disclosure of which is incorporated herein by reference. As previously noted, suitable fluid materials for use in the insert 128 include commercially available hydrogels. An example of such a hydrogel may be a hydrophilic acrylate derivative, with each polymer chain having several sequences of units with pendant hydrophilic groups, called soft blocks, and several sequences of pendant nitrile groups, called hard blocks. The lengths of the blocks, and/or the nature of the side groups, as well as the overall hydrophilicity of the polymer, are varied depending upon production conditions.

An advantage of using a hydrogel is that hydrogel based inserts 128 act as a diffusion barrier that allows the agents to be released over a period of hours. It is contemplated that other hydrogels and agent-releasing inserts may be used in the embodiments of the present invention. For example, other hydrogels which are contemplated by the present invention include compounds such as polyhydroxy-ethyl methacrylate, chemically or physically crosslinked polyacrylaminde, polyvinyl alcohols, poly(N-vinyl pyrolidone), polyethylene oxide, and hydrolyzed polyacrylonitrile. Polysaccharide-based hydrogels, such as covalent or chemically crosslinked polyvalent metal salts of alginates, pectins, carboxymethylcellulose, heparin and hyaluronic acid, as well as hydrogels containing chitin, chitosan, gellan, pullulan and xanthan are also contemplated by the present invention.

The mouthguard 100 may be customized to the particular wearer using known boil and bite techniques. For example, as shown in FIG. 5, the mouthguard 100 includes a bite layer 144 lining the inner surfaces of the inside wall 106, outside wall 108 and occlusal wall 110, except for the area of the inset 126. The bite layer 144 is typically formed from a low temperature thermoplastic material which softens at or below the boiling point of water. On the other hand, the mouthguard 100 is formed from higher temperature thermoplastic materials which will not soften at the lower softening temperature of the bite layer 144. In use, the mouthguard 100 is customized by placing the mouthguard in boiling water so as to soften the bite layer 144. The mouthguard 100 is thereafter positioned within the wearer's mouth, biting down with sufficient compression to mold the bite layer 144 to conform to the wearer's teeth. Upon cooling of the mouthguard 100, the bite layer 144 hardens to its original state providing the wearer with a customized mouthguard.

During the boil and bite process, it is contemplated that blank inserts will be inserted into the inset 126. These blank inserts may be in the nature of a body of solid polymer material, such as the polymer material forming the mouthguard. This will prevent potential damage to the inset 126 such as distortion of shape or intrusion of bite layer 144 material into the inset that would prevent the proper seating of an insert 128 having the aforementioned cell-like structure and/or contained fluid material. The blank inserts can also be used in the mouthguard 100 if the insert 128 is destroyed during, use, and no replacement inserts are available. As such, the mouthguard 100 by being formed from polymer materials, will provide some degree of shock absorbing property, independent of the insert 128.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A dental device comprising a carrier adapted for receiving an arch of teeth, said carrier including an outer wall having at least one insert therein, said insert comprising a shock absorbing body adapted to be rendered inoperable upon application of a sufficient force thereto.

2. The dental device of claim 1, wherein said insert is integrally formed with said carrier.

3. The dental device of claim 1, further including at least one inset within said outer wall, said insert adapted to be removably secured within said inset.

4. The dental device of claim 1, wherein said insert includes a plurality of voids.

5. The dental device of claim 4, further including a fluid material within said voids selected from the group consisting of hydrogels, amorphous solids, semi-solids, gels, liquids or gases.

6. The dental device of claim 5, wherein said material includes a beneficial agent.

7. The dental device of claim 1, wherein said insert comprises an open cell structure.

8. The dental device of claim 7, wherein said structure comprises a honeycomb structure.

9. The dental device of claim 1, wherein said insert extends along said outer wall from a position of the wearer's left canine to the wearer's right canine.

10. The dental device of claim 1, wherein said outside wall has an inside surface, said insert releasably positioned within said inside surface.

11. A dental device comprising:
a carrier having an outside wall, an inside wall, and an occlusal wall connecting said outside wall to said inside wall, said outside wall having at least one inset, at least one shock absorbing insert adapted to be removably received within said inset, said insert comprising an open cell body of deformable material having a plurality of voids, and a fluid material within said plurality of voids, whereby deformation of said body at least partially expels said fluid material from said voids.

12. The dental device of claim 11, wherein said fluid material comprises a substance selected from the group consisting of hydrogels, amorphous solids, semi-solids, gels, liquids or gases.

13. The dental device of claim 12, wherein said substance includes a beneficial agent.

14. The dental device of claim 11, wherein said body comprises a honeycomb structure.

15. The dental device of claim 11, wherein said insert extends along said outer wall from a position of the wearer's left canine to the wearer's right canine.

16. The dental device of claim 11, wherein said outside wall has an inner surface, said inset positioned within said inner surface.

17. The dental device of claim 11, wherein said open cell body has opposing first and second open ends.

18. The dental device of claim 17, further including a backing layer positioned overlying said first open end of said body.

19. The dental device of claim 18, further including a fluid material permeable layer overlying said second open end of said body.

20. A dental device comprising:
a carrier adapted for receiving an arch of teeth, said carrier including an outside wall, and a shock absorbing body within a portion of said outside wall, said body having an operative shock absorbing condition and an inoperative condition, said body irreversibly changing from said operative shock absorbing condition to said inoperative condition upon application of a sufficient force thereto.

21. The dental device of claim 20, wherein said body comprises an open cell structure having a plurality of voids.

22. The dental device of claim 21, wherein said structure comprises a honeycomb structure.

23. The dental device of claim 18, further including a fluid material within said voids selected from the group consisting of hydrogels, amorphous solids, semisolids, gels, liquids or gases.

24. The dental device of claim 23, further including a fluid material permeable layer overlying one side of said body and a fluid impermeable layer overlying the other side of said body, thereby confining said fluid material therebetween.

25. The dental device of claim 20, wherein said body is integrally formed with said carrier.

26. The dental device of claim 20, wherein said body is removably insertable within said outside wall of said carrier.

27. The dental device of claim 20, wherein said body extends along said outer wall from a position of the wearer's left canine to the wearer's right canine.

28. An insert adapted for use in a shock absorbing dental device, said insert comprising a body having an operative shock absorbing condition and an inoperative condition, said body irreversibly changing from said operative shock absorbing condition to said inoperative condition upon application of a sufficient force thereto.

29. The insert of claim 28, wherein said body includes a plurality of voids.

30. The insert of claim 29, further including a -fluid material within said voids selected from the group consisting of hydrogels, amorphous solids, semisolids, gels, liquids or gases.

31. The dental device of claim 30, wherein said fluid material includes a beneficial agent.

32. The dental device of claim 31, further including a fluid material permeable layer overlying one side of said body and a fluid impermeable layer overlying the other side of said body, thereby confining said fluid material therebetween.

33. The dental device of claim 31, wherein at least a portion of said fluid material is expelled from said voids upon said body changing t said inoperative condition.

34. The dental device of claim 33, wherein said fluid material is expelled by the deformation of said body.

35. The dental device of claim 34, wherein said deformation comprises crumpling of said body.

36. The dental device claim 28, wherein said body comprises an open cell structure.

37. The dental device claim 36, wherein said structure comprises a honeycomb structure.

38. An insert adapted for use in a shock absorbing dental device, said insert comprising a first backing layer, a body supported on said backing layer, said body comprising an open cell structure including a plurality of voids having opposing first and second open ends, and a fluid material within said plurality of voids, said first backing layer closing said first ends of said voids.

39. The insert of claim 38, wherein said body is deformable upon application of a sufficient force thereto to cause said fluid material to be discharged from said voids.

40. The insert of claim 38, wherein said fluid material comprises a substance selected from the group consisting of hydrogels, amorphous solids, semisolids, gels, liquids or gases.

41. The insert of claim 38, wherein said body comprises a honeycomb structure having said first ends of said voids closed by said first backing layer.

42. The insert of claim 41, further including a second backing layer at lest partially closing said second ends of said voids.

43. The insert of claim 42, wherein said second backing layer is permeable to said fluid material.

44. The insert of claim 38, wherein said body has an operative condition and an inoperative condition, said body irreversibly changing from said operature condition to said inoperative condition upon application of a sufficient force thereto.

45. A method for protecting the teeth of a user from an impact, said method comprising positioning an arch of teeth within a channel formed in a carrier, said carrier including an outer wall having at least one insert therein, said insert comprising a shock absorbing body adapted to be rendered impermeable upon application of a sufficient force thereto, and replacing said insert with another one of said inserts when said insert is rendered inoperable upon application of a sufficient force thereto.

46. The method of claim 45, further including at least one inset within said outer wall, said insert adapted to be removably secured within said inset.

47. The method of claim 45, wherein said insert includes a plurality of voids.

48. The method of claim 47, further including a fluid material within said voids selected from the group consisting of hydrogels, amorphous solids, semi-solids, gels, liquids or gases.
